(19) United States
(12) Patent Application Publication
(10) Pub. No.: US 2010/0186023 A1
(43) Pub. Date: Jul. 22, 2010

(54) PRINTING SYSTEM AND PCI DEVICE

(75) Inventors: Yi-Fang Wu, Tu-Cheng (TW); Yong-Hui Xiao, Shenzhen City (CN); Qing-Hua Liu, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/543,753

(22) Filed: Aug. 19, 2009

(30) Foreign Application Priority Data
Jan. 16, 2009 (CN) 200910300231.3

(51) Int. Cl. G06F 9/44; G06F 13/20

(52) U.S. Cl. 719/327; 710/313

(57) ABSTRACT

A printing system includes a computer with an operating system, and a PCI device communicating with the computer. The PCI device includes a receiving module, a detection module, an installing module and a program module. The program module stores a printer driver program compatible with the computer operating system. The receiving module is capable of receiving instructions sent to the PCI device from the computer operating system. The detection module is capable of detecting whether there is a printer driver program for an attached printer stored in the computer after the receiving module receives the instructions. The installing module is capable of installing the printer driver program stored by the program module onto the computer if the proper printer driver program is not detected in the computer by the detection module.

### BACKGROUND

1. Technical Field

The present disclosure relates to printing systems and Peripheral Component Interconnect (PCI) devices, and particularly to a printing system integrated with a PCI card, which has a storage unit.

2. Description of Related Art

Many electronic devices, such as a computer with PCI devices, mobile telephone, printer, digital photo frame and so on, need drivers to function properly. For example, a printer driver should be installed in a computer communicating with a printer, so that the computer can use the printer to print files stored in the computer. However, it is very inconvenient and time-consuming to find and correctly install compatible driver programs for the electronic devices.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a printing system.

FIG. 2 is a bock diagram of a storage unit of a PCI device of the printing system of FIG. 1.

FIG. 3 is a flow chart of a method for installing a PCI device driver program and a printer driver program to a computer of the printing system of FIG. 1.

FIG. 4 is a flow chart of a method for installing a printing program to a mobile device of the printing system of FIG. 1.

### DETAILED DESCRIPTION

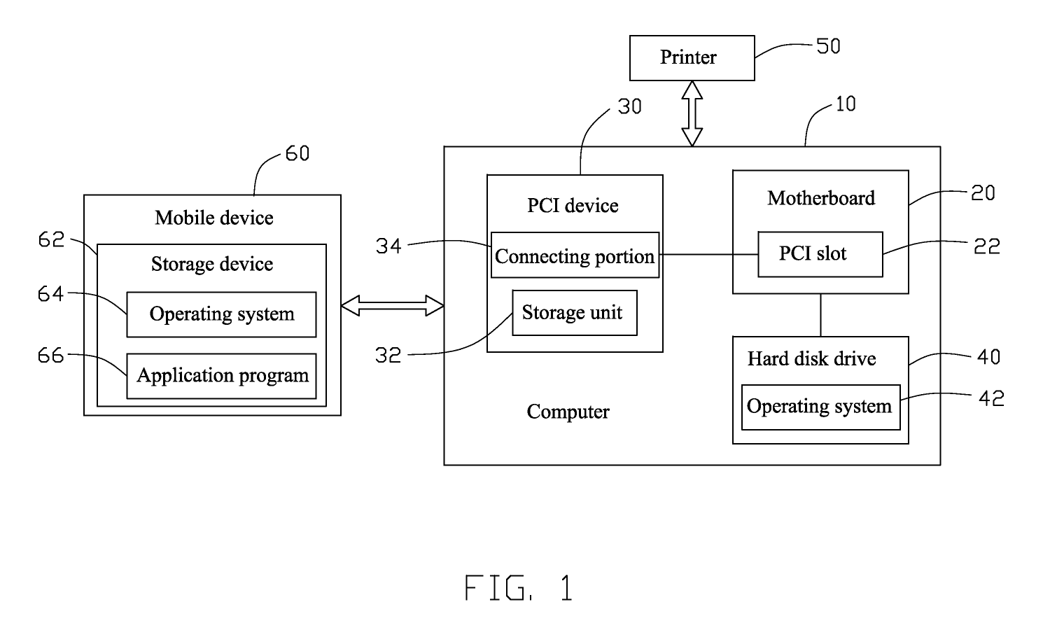

Referring to FIG. 1, a printing system includes a computer 10, a printer 50, and a mobile device 60. The printer and the mobile device 60 are in communication with the computer 10. The mobile device 60 may be, for example, a mobile telephone, a personal digital assistant, a digital photo frame, or other electronic device, and includes a storage device 62. An operating system 64 and a plurality of application programs 66 can be installed in the storage device 62.

The computer 10 includes a motherboard 20, a Peripheral Component Interconnect (PCI) device 30, and a hard disk drive with an operating system 42 installed therein. The motherboard 20 is electrically coupled to the hard disk drive 40 and has a PCI slot 22 following the PCI or PCI express standards accordingly.

The PCI device 30 may be, for example, a wireless network card or other PCI card that is capable of communicating with the printer 50 and the mobile device 60 through the computer 10. The PCI device 30 includes a storage unit 32 and a connecting portion 34. The storage unit 32 may be, for example, a flash memory and is integrated with the PCI device following the PCI or PCI express standards. The connecting portion 34 is configured to engage in the PCI slot 22 of the motherboard 20 to electrically couple the PCI device 30 to the motherboard 20, and the mother board 20 and the PCI device 30 can thereby communicate with each other following PCI or PCI express standards.

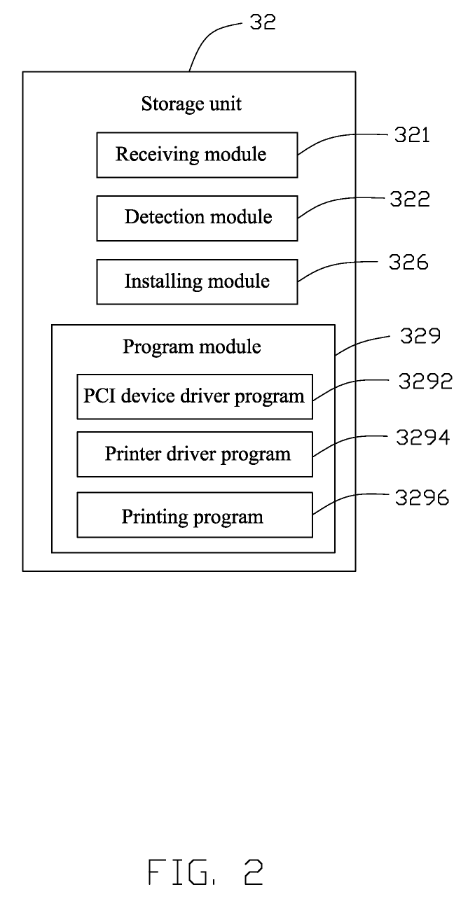

Referring also to FIG. 2, the storage unit 32 includes a receiving module 321, a detection module 322, an installing module 326, and a program module 329. A plurality of PCI driver programs 3292, printer driver programs 3294, and printing programs 3296 is stored in the program module 329. One of the PCI driver programs 3292 is compatible with the computer operating system 42, and when the one PCI driver program 3292 is installed in the hard disk drive 40, the PCI device 30 is capable of correctly executing its functions under the computer operating system 42. One of the printer driver programs 3294 is compatible with the computer operating system 42 and the printer 50, and when the one printer driver program 3294 is installed in the hard disk drive 40, the printer 50 can be used to print files under the computer operating system 42. The printing program 3296 is capable of being installed in the mobile device storage device 62, so that the mobile device 60 can use the printer 50 to print files. The receiving module 321 is capable of receiving executing instructions and information sent to the PCI device storage unit 32. The executing instructions may be, for example, instructions for printing files or finding a printer. The detection module 322 is capable of detecting information of the computer operating system 42, the type of the printer 50, and detecting whether there is a compatible PCI driver program 3292 and a compatible printer driver program 3294 installed in the hard disk drive 40, and whether a compatible printing program 3296 is installed in the mobile device storage device 62. The information of the computer operating system 42 includes a name and an edition of the computer operating system 42. The installing module 326 is capable of installing the one compatible PCI driver program 3292 and the one compatible printer driver program 3294 to the hard disk drive 40, and installing the printing program 3296 in the mobile device storage device 62.

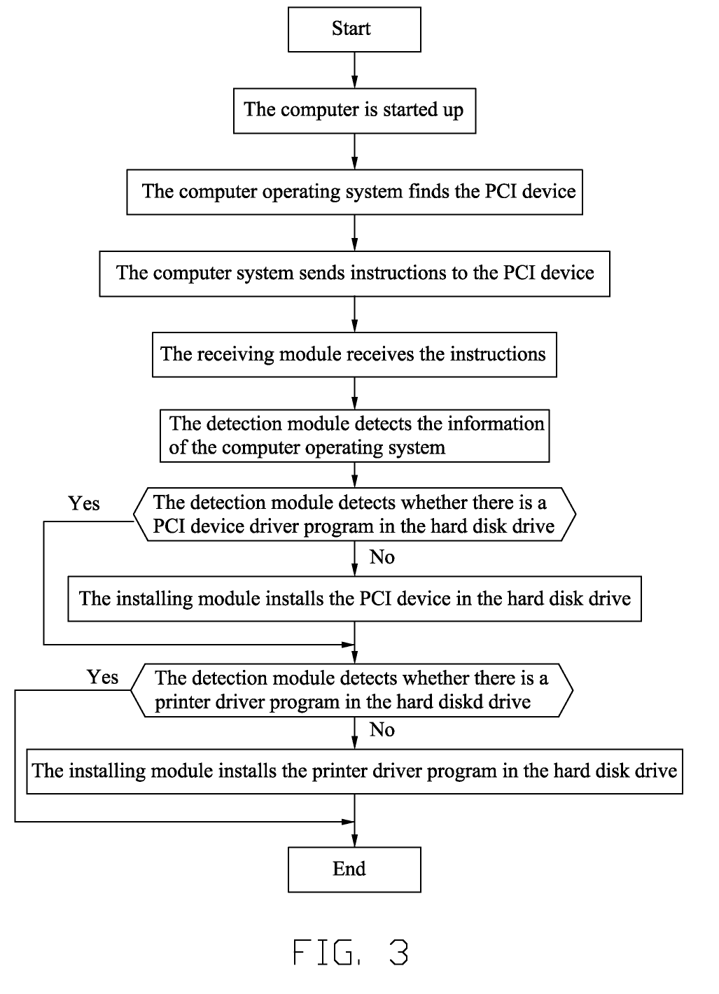

Referring also to FIG. 3, in use, the connecting portion 34 of the PCI device 30 is engaged in the PCI slot 22 of the motherboard 20. The computer 10 is started up. The computer operating system 42 finds the PCI device 10, and sends an executing instruction to the PCI device storage unit 32. The receiving module 321 receives the executing instruction, and the detection module 322 detects the information of the computer operating system 42 and whether there is a compatible PCI driver program installed in the hard disk drive 40. If the compatible PCI driver program is detected, the PCI device 30 can then execute its functions. If no compatible PCI driver program is detected, the installing module 326 installs a compatible one of the PCI driver programs 3292, so that the PCI device 30 can execute its functions.

The detection module 322 further detects whether there is a printer driver program installed in the hard disk drive 40. If the printer driver program is detected, the printer can then be used to print files. If no printer driver program is detected, the installing module 326 installs the compatible one of the printer driver programs 3294 of the program module 329 to the hard disk drive 40. The printer 50 can then be used to print files.

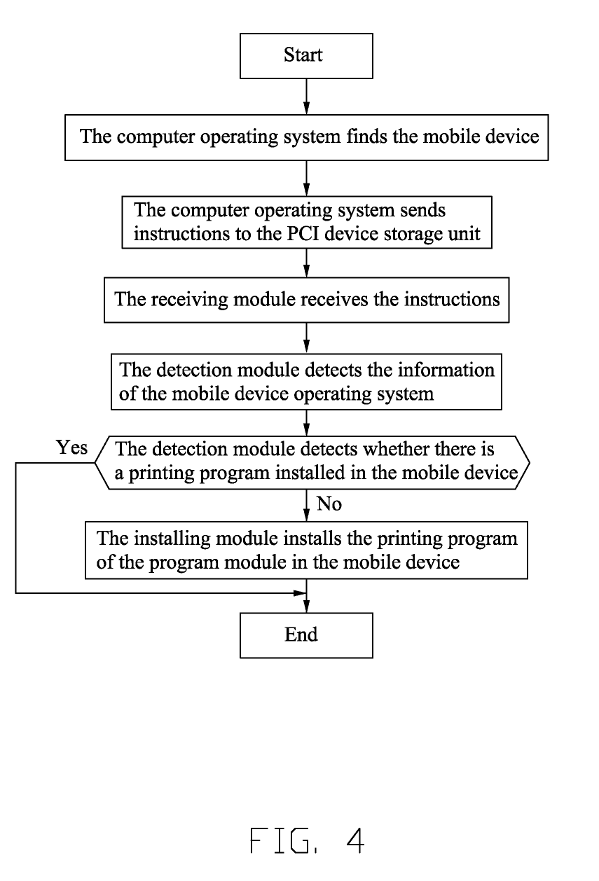

Referring also to FIG. 4, after the mobile device 60 communicates with the computer 10 via the PCI device 30. The computer operating system 42 sends an executing instruction to the PCI device storage unit 32. The receiving module 321 receives the executing instruction, and the detection module 322 detects the information of the mobile device operating system 64 and whether there is a printing program installed in the mobile device storage device 62. If a printing program is detected, the mobile device 60 can use the printer 50 to print files of the mobile device 60 with the print program when the application program 66 is executed. If no printing program is detected, the installing module 926 installs the printing program 3296 to the mobile device storage device 62. The mobile device 60 can then be used to print files of the mobile device 60 when the application program 66 is executed.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A printing system comprising:
a computer with an operating system; and
a Peripheral Component Interconnect (PCI) device communicating with the computer; the PCI device comprising a receiving module, a detection module, an installing module and a program module; wherein the program module stores a printer driver program compatible with the computer operating system; the receiving module is capable of receiving instructions sent to the PCI device from the computer operating system, the detection module is capable of detecting whether there is a printer driver program stored in the computer; the installing module is capable of installing the printer driver program stored by the program module onto the computer if a proper printer driver program is not detected by the detection module.

2. The printing system of claim 1, wherein the PCI device is a wireless network card with a flash memory.

3. The printing system of claim 1, wherein the PCI device further comprises a storage unit for storing the receiving module, the detection module, the installing module and the program module.

4. The printing system of claim 1, wherein the detection module is further capable of detecting operating system information, the operating system information comprises name and edition of the operating system.

5. The printing system of claim 1, wherein the detection module is further capable of detecting printer information of a printer, the printer information comprises the printer type.

6. The printing system of claim 1, wherein the program module stores a PCI device driver program.

7. The printing system of claim 6, wherein the detection module is capable of further detecting whether there is a PCI device driver program installed in the computer.

8. The printing system of claim 7, wherein the installing module is capable of installing the PCI device driver program of the program module in the computer when no PCI device driver program is detected by the detection module.

9. A printing system comprising:
a computer with an operating system;
a mobile device communicating with the computer; and
a Peripheral Component Interconnect (PCI) device communicating with the computer; the PCI device comprising a receiving module, a detection module, an installing module and a program module; the program module storing a printing program;
the receiving module capable of receiving instructions sent to the PCI device from the computer operating system; the detection module capable of detecting whether there is a printing program stored in the mobile device after the receiving module receives the instructions; the installing module capable of installing the printing program of the program module to the mobile device if a printing program is not detected by the detection module.

10. The printing system of claim 9, wherein the PCI device further comprises a storage unit for storing the receiving module, the detection module, the installing module and the program module.

11. The printing system of claim 9, wherein the detection module is further capable of detecting operating system, and the operating system information comprises name and edition of the operating system.

12. The printing system of claim 9, wherein the program module stores a PCI device driver program.

13. The printing system of claim 12, wherein the detection module is capable of further detecting whether there is a PCI device driver program installed in the computer.

14. The printing system of claim 13, wherein the installing module is capable of installing the PCI device driver program of the program module in the computer when no PCI device driver program is detected by the detection module.

15. The printing system of claim 9, wherein the program module stores a printer driver program.

16. The printing system of claim 15, wherein the detection module is capable of further detecting whether there is a printer driver program installed in the computer.

17. The printing system of claim 15, wherein the installing module is capable of installing the printer driver program of the program module in the computer when no printer driver program is detected by the detection module.

18. A Peripheral Component Interconnect (PCI) device communicating with an electronic device, the PCI device comprising:
a program module storing a program;
a receiving module receiving instructions sent to the PCI device;
a detection module detecting whether the program of the program module is installed in the electronic device; and
an installing module installing the program of the program module after the program is not detected by the detection module.

19. The PCI device of claim 18, wherein the PCI device is a wireless network card with a flash memory.

20. The PCI device of claim 18, wherein the PCI device further comprises a storage unit for storing the receiving module, the detection module, the installing module and the program module.
